(19) United States
(12) Patent Application Publication
(10) Pub. No.: US 2007/0134458 A1
(43) Pub. Date: Jun. 14, 2007

(54) Aromatic polyamide tubing for vehicle applications

(76) Inventors: Brad A. Lovett, West Bloomfield, MI (US); Andrew M. Rosenberg, Almont, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/588,710

(22) PCT Filed: Feb. 4, 2005
(86) PCT No.: PCT/US05/03942

§ 371 Date: Aug. 7, 2006

Related U.S. Application Data
(60) Provisional application No. 60/542,729, filed on Feb. 6, 2004.

(51) Int. Cl. B32B 1/08; B29C 47/00

(52) U.S. Cl. 428/36.91; 428/36.9

(57) ABSTRACT

A vehicle tube (14) includes a layer of aromatic polyamide (22). In one example, an outer layer of aromatic polyamide (24) is bonded to the layer aromatic polyamide (22). In another example, the layer of aromatic polyamide (22) includes filler and modifying agents (34) and is electrically modifying agents (34) include carbon powder, carbon nanotubes, metal fiber, heat-stabilizing agent, impact-modifying agent example, the outer layer of aromatic polyamide (24) includes a corrugated outer surface portion (70) to provide flexibility to the (14). One example method includes extruding an aromatic polyamide barrier layer (22), extruding a second aromatic polyamide barrier layer (24) coaxially with the first aromatic polyamide layer (22), and bonding the second aromatic polyamide barrier layer (24) to the first aromatic polyamide barrier layer (22).

### BACKGROUND OF THE INVENTION

This invention relates generally to an aromatic polyamide tubing for use in vehicles.

Vehicles utilize various types of tubes. The type of tube depends on the function and operating environment of the vehicle system.

For example, rubber tubes are commonly used in vacuum brake systems, routing from the intake manifold on the engine to the vacuum brake booster. The vacuum that this tube conveys provides the power assist for braking. Vacuum brake tubing must be capable of withstanding the elevated temperatures of the vacuum brake system and must be resistant to fuel vapor since these vapors can migrate out of the intake manifold after the engine is shut off. Vehicle engine cooling systems also utilize rubber tubes for handling water-glycol coolant Rubber tubes in the engine cooling system must be capable of withstanding the elevated temperatures of the engine cooling system while in contact with the water-glycol coolant.

A conventional rubber tube usually includes several layers of rubber with fiber reinforcements in between each layer to provide strength and durability. Rubber tubes are commonly produced by extruding an inner rubber layer over a mandrel. However, they can also be produced without using mandrels. The fiber reinforcements are braided around the outside of the inner layer, and an outer rubber layer is extruded over the fiber reinforcements. Additional fiber reinforcements and rubber layers may be applied as necessary. The entire tube is then cured in a curing process that transforms the raw polymer material into a cross-linked elastomer. A drawback to this process is that it is both laborious and expensive.

Thermoplastic tubes are used in fuel systems and must be capable of withstanding the elevated temperatures associated with the fuel system while in contact with fuel. Fuel tubes usually include thermoplastic layers fabricated from materials such as common grade polyamide (e.g. PA12, PA66, PA612, PA6, etc.), fluoropolymer, or ethylene vinyl alcohol. A drawback of polyamide tubes is that they may not possess adequate thermal or chemical resistance for many non-fuel vehicle applications. As a result, polyamide tubes may degrade under extreme elevated temperatures or prolonged exposure to elevated temperatures. Fluoropolymers generally provide better thermal resistance than polyamide and ethylene vinyl alcohol, but are more expensive and more difficult to process.

Accordingly, a thermoplastic tube providing all the advantages of thermoplastics along with the heat and chemical resistance of elastomers is needed in modern vehicle systems.

### SUMMARY OF THE INVENTION

A vehicle tube includes a layer of aromatic polyamide. In one example, the tube includes a single layer aromatic polyamide that includes a heat-stabilizing additive.

In another example, a layer of aromatic polyamide is bonded to another layer of thermoplastic. The layer of thermoplastic can be a layer of aromatic polyamide or a layer of polypropylene, polyethylene, fluoropolymer, or polyamide.

In another example, an outer layer of aromatic polyamide is bonded to an inner layer of aromatic polyamide, and the outer layer of aromatic polyamide includes a corrugated outer surface portion to provide flexibility to the tube.

One example method includes extruding an aromatic polyamide barrier layer. In another example, a second aromatic polyamide barrier layer is extruded coaxially with the aromatic polyamide barrier layer and bonded to the aromatic polyamide barrier layer using an intermediate thermoplastic layer between the aromatic polyamide barrier layer and the second aromatic polyamide barrier layer.

### BRIEF DESCRIPTION OF THE DRAWINGS

FIG. 1 schematically illustrates a vehicle including a tube;

FIG. 2 schematically illustrates a cross-sectional view of a first example aromatic polyamide tubing;

FIG. 3 schematically illustrates a cross-sectional view of a second embodiment of an example aromatic polyamide tube;

FIG. 4 schematically illustrates a cross-sectional view of a third embodiment of an example aromatic polyamide tube;

FIG. 5 schematically illustrates a cross-sectional view of a fourth example corrugated aromatic polyamide tube;

FIG. 6 schematically illustrates a cross-sectional view of a fifth embodiment of an example corrugated aromatic polyamide tube;

FIG. 7 schematically illustrates a cross-sectional view of a sixth embodiment of an example corrugated aromatic polyamide tube;

FIG. 8 schematically illustrates a cross-sectional view of a seventh embodiment of an example corrugated aromatic polyamide tube; and

FIG. 9 schematically illustrates a cross-sectional view of a eighth embodiment of an example corrugated aromatic polyamide tube.

### DETAILED DESCRIPTION OF THE PREFERRED EMBODIMENT

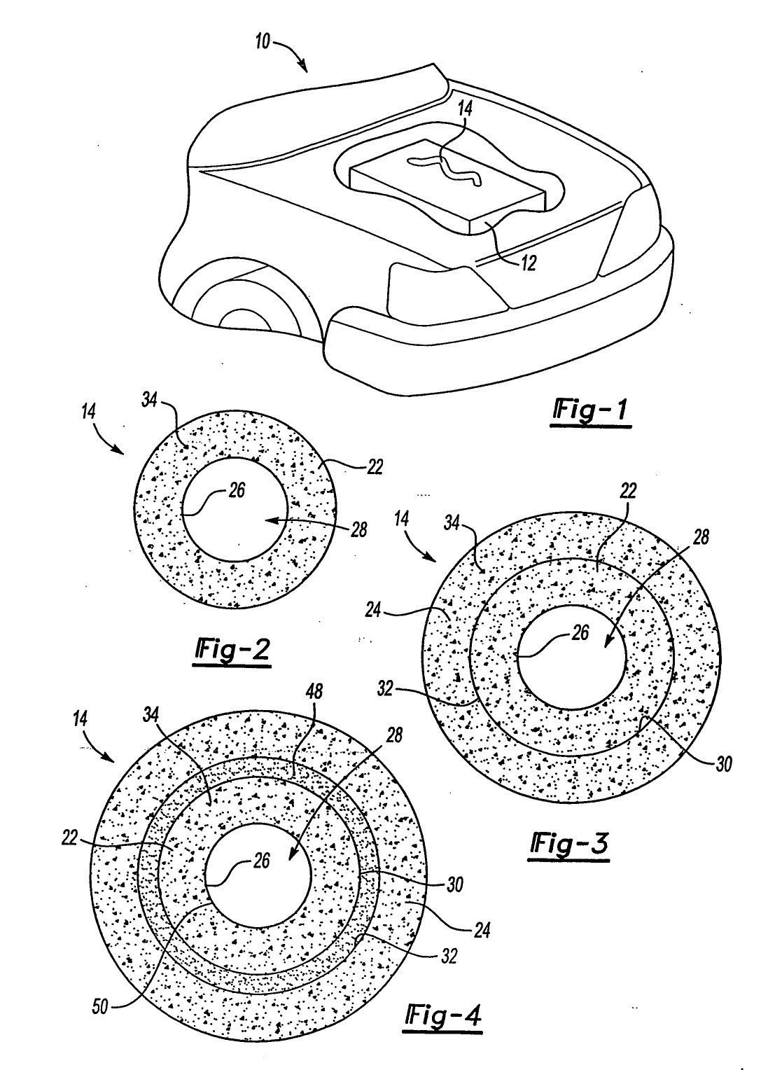

FIG. 1 illustrates a vehicle 10 including a vehicle system 12 having a tube 14. The vehicle system 12 can be an engine cooling system, an air conditioning system, a transmission oil cooling system, a fuel system, or a vacuum brake system. However, it is to be understood that this list of vehicle systems is non-exclusive and other types of vehicle systems can be utilized. The tube 14 operates under a variety of conditions in the vehicle system 12, including contact with chemicals (i.e., vehicle fluids) and/or exposure to elevated temperatures.

In the example shown, the primary function of the tube 14 is to carry and transport a vehicle fluid in the vehicle system 12, such as a fuel. In order to maintain proper function over a desired life of the tube 14, the tube 14 is chemically resistant to the vehicle fluid and thermally resistant to elevated temperatures required of the application.

FIG. 2 shows a first example embodiment of the tube 14 including a single layer 22. The layer 22 includes an inner surface 26 defining a conduit 28 through which the vehicle fluid may be carried and transferred. The layer 22 is made of an aromatic polyamide and includes amide groups (refers to the chemical group CNOH₂) and aromatic rings. At least a portion of the amide groups are attached to the aromatic rings. An aromatic ring as used in this description refers to a portion of a molecular structure of the aromatic polyamide that includes six carbon atoms arranged in a ring-like structure (commonly referred to as a benzene ring).

Using aromatic polyamide in the tube 14 may provide the benefit of increased resistance to elevated temperatures, increased resistance to chemicals, and increased resistance to permeation of the vehicle fluid through the tube 14 compared to previously known tubes.

In one example, the aromatic polyamide has at least 50% of the amide groups attached to aromatic rings. This may provide a desirable balance of heat and chemical resistance. In another example, the aromatic polyamide may be expressed in terms of a chemical repeat unit, wherein the chemical repeat unit includes an amide group attached to an aromatic ring.

In another example, Zytel™ HTN (High Temperature Nylon), available from DuPont™ (Wilmington, Del.), is used to form the tube 14. Polyphthalamide, available from Solvay™ Engineered Polymers (Auburn Hills, Mich.), or Polyamide 9T available from Kuraray, may alternatively be used to form the tube 14. It should be understood, however, that alternative sources of aromatic or semi-aromatic polyamide may also be used.

In the example shown, the layer 22 is made of a composite of aromatic polyamide and fillers or modifying agents 34. Example fillers and modifying agents 34 used to form the aromatic polyamide composite include carbon powder, carbon fiber, carbon nanotubes, metallic fiber, heat-stabilizing agents, impact-modifying agents, pigment, and mixtures thereof. The fillers and modifying agents 34 enhance the electrical conductivity, strength, impact resistance, appearance, elongation, and/or temperature resistance of the tube 14, for example.

In one example, the aromatic polyamide of the layer 22 includes between 0.1 wt% and 10 wt% anti-oxidant heat-stabilizing agent, between 1 wt% and 50 wt% of an elastomeric or thermoplastic olefin impact modifying agent, and between 0.01 wt% and 15 wt% of a powder or dye type of pigment. The anti-oxidant heat-stabilizing agent increases the heat resistance of the aromatic polyamide during forming of the tube 14, during use of the tube 14, or both. The elastomeric or thermoplastic olefin impact modifying agent to increases the resistance of the tube 14 to impacts. The powder or dye type of pigment enhances the aesthetic of the layer 22. As is known, the powder or dye types of pigment is added primarily for appearance, however, the addition of the powder or dye may slightly change the electrical, mechanical, or other properties of the layer 22.

In one example tube 14, the fillers and modifying agents 34 are used to enhance the electrical properties of the layer 22, such that the surface electrical resistivity of the layer 22 is between approximately 10² and 10⁷ ohm/sq. In a vehicle system 12 (FIG. 1) that transports fuel, for example, electrical dissipation of static electricity may be a desired feature. Desirable fillers and modifying agents 34 for enhancing the electrical resistivity of the tube 14 include carbon powder, carbon fiber, carbon nanotubes, metallic fiber and mixtures thereof added in effective amounts to the aromatic polyamide material. The amount of fillers and modifying agents 34 is sufficient to change a characteristic of the aromatic polyamide composite compared to the aromatic polyamide without any fillers and modifying agents 34. In one example, carbon black is added to the aromatic polyamide to change the electrical resistivity of the aromatic polyamide layer.

FIG. 3 shows a second example embodiment of the tube 14 including the layer 22 and an outer layer 24 having an inner surface 30. The outer layer 24 is bonded to an outer surface 32 of the layer 22. In one example, each of the layer 22 and outer layer 24 are made of an aromatic polyamide. In another example, the outer layer 24 is made from other thermoplastic materials such as polypropylene, polyethylene, fluoropolymer, and polyamide. The aromatic polyamide includes amide groups and aromatic rings, and at least a portion of the amide groups are attached to aromatic rings, as described above. Using aromatic polyamide for both the layer 22 and the outer layer 24 may provide the benefit of having two barrier layers to prevent at least a portion of the fuel from permeating through the tube 14, whereas previously known tubes include only a single barrier layer (a fluoropolymer, for example).

In one example, the aromatic polyamide of at least one of the layer 22 and the outer layer 24 has at least 50% of the amide groups attached to aromatic rings, as described above. This may provide a desirable balance of heat and chemical resistance.

In another example, the layer 22 includes fillers and modifying agents 34, as described above. In other examples, the outer layer 24 also includes filler and modifying agents 34 to enhance the electrical conductivity, strength, impact resistance, elongation, and/or temperature resistance of the tube 14, for example.

The tube 14 has a corresponding total thickness and each of the layer 22 and outer layer 24 have a corresponding layer thickness. In one example, the thickness of the outer layer 24 is 50% to 95% of the total thickness of the tube 14. This may provide the benefit of reducing the expense of the tube 14 where more expensive fillers and modifying agents 34 are used to make the layer 22 electrically conductive, for example.

The layer 22 and outer layer 24 are formed by a known co-extrusion process. One of ordinary skill in the art would recognize the skills necessary for co-extruding the aromatic polyamide layers.

FIG. 4 shows a third example embodiment of a tube 14 including the layer 22, the outer layer 24, and a middle layer 48 interposed between the layer 22 and the outer layer 24. The middle layer 48 acts as an adhesive to bond an inner surface 32 of the outer layer 24 to the outer surface 30 of the layer 22.

In one example, each of the layer 22 and outer layer 24 is made of aromatic polyamide. The outer layer 24 can also be made from other thermoplastic materials, such as polypropylene, polyethylene, fluoropolymer, and polyamide. In one example, the layer 22 includes fillers and modifying agents 34, as described above. In other examples, the outer layer 24 also includes fillers and modifying agents 34 to enhance the electrical conductivity, strength, impact resistance, elongation, and/or temperature resistance of the tube 14, for example.

The middle layer 48 is made a thermoplastic material including, for example, polyvinylidene fluoride, ethylene chlorotrifluoroethylene, ethylene tetrafluoroethylene, polyamide, modified polyamide, polyolefin, ethylene vinyl alcohol, polyester, polybutylene napthalate, other thermoplastic, or combinations thereof. In one example, the middle layer 48 provides dual functions of bonding the layer 22 and the outer layer 24 together and acting as an additional barrier layer to permeation of the vehicle fluid through the tube 14.

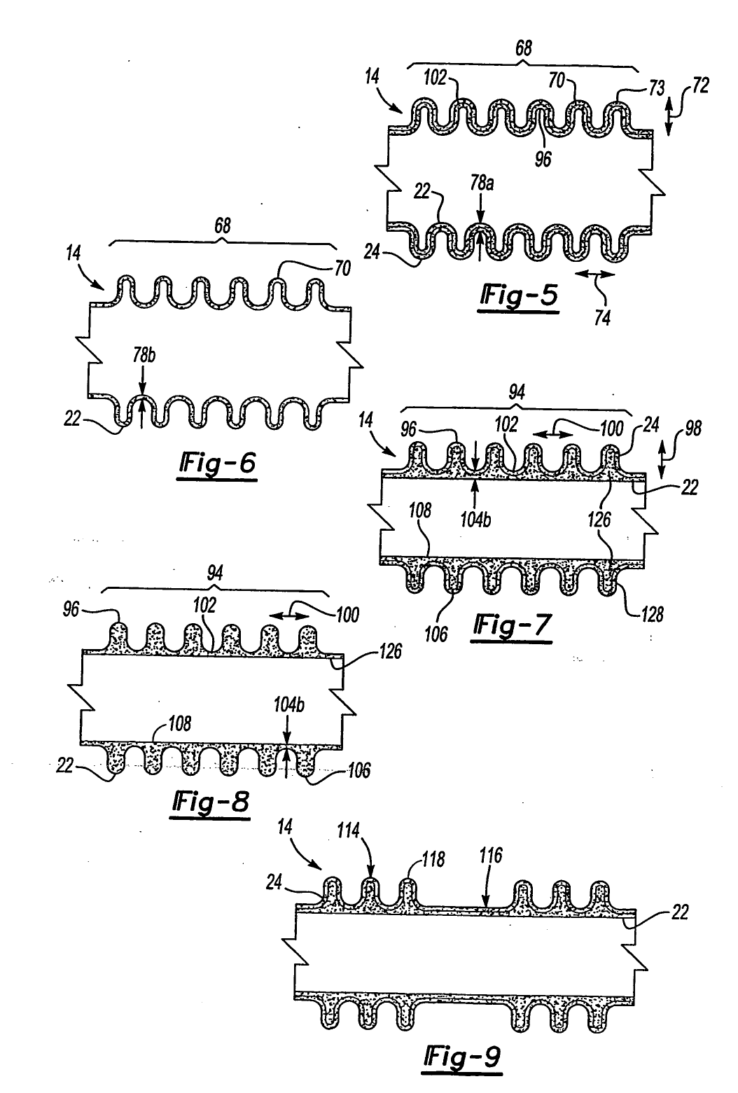

FIG. 5 illustrates a fourth example tube 14 including the layer 22 and the outer layer 24 in a corrugated configuration. The layer 22 and outer layer 24 are made from aromatic polyarmide, as described above. In one example, the layer 22 includes fillers and modifying agents 34, as described above. In other examples, the outer layer 24 also includes fillers and modifying agents 34 to enhance the electrical conductivity, strength, impact resistance, elongation, and/or temperature resistance of the tube 14, for example.

The outer layer 24 includes a corrugated outer portion 68 having at least one corrugation 70 that provides flexibility to the tube 14. The corrugation 70 generally has a U-shape, although other shapes are possible, and includes a height 72, a length 74, a radius 73 and a thickness 78a. In this example, the corrugation 70 extends through the entire thickness 78 of the tube 14. That is, the thickness of each of the layer 22 and the outer layer 24 are essentially constant over a length of the tube 14. Alternatively, in a fifth embodiment, the layer 22 may be utilized as a single layer having a thickness 78b in a similar corrugated configuration, as illustrated in FIG. 6.

FIG. 7 illustrates a sixth example tube 14 including the layer 22 and the outer layer 24 in a corrugated configuration. The layer 22 and the outer layer 24 are made of aromatic polyamide, as described above. In one example, the layer 22 includes fillers and modifying agents 34, as described above. In other examples, the outer layer 24 also includes fillers and modifying agents 34 to enhance the electrical conductivity, strength, impact resistance, elongation, and/or temperature resistance of the tube 14, for example.

The outer layer 24 includes an outer corrugated portion 94 having at least one corrugation 96 that provides flexibility. The corrugation 96 generally has a U-shape, although other shapes are possible, and includes a height 98, a length 100, a radius 102 and a thickness 104a. In this example, the corrugation 96 does not extend through the entire thickness 104 of the tube 14. That is, the layer 22 includes a corrugated outer surface portion 106 and a non-corrugated inner surface portion 108. Alternatively, the layer 22 may be utilized in a similar corrugated configuration having only the layer 22 and corresponding thickness 104b, as illustrated in the seventh embodiment shown in FIG. 8.

FIG. 9 illustrates an eighth example tube 14 including the layer 22 and the outer layer 24 bonded to the layer 22. The layer 22 and outer layer 24 are made of aromatic polyamide, as described above. In one example, the layer 22 includes fillers and modifying agents 34, as described above. In other examples, the outer layer 24 also includes fillers and modifying agents 34 to enhance the electrical conductivity, strength, impact resistance, elongation, and/or temperature resistance of the tube 14, for example.

The outer layer 24 includes alternating corrugated outer surface potions 114 and non-corrugated outer surface portions 116. In the example shown, the corrugated outer surface portions 114 include three corrugates 118, however, it is to be understood that additional or fewer corrugates 118 may also be used. The alternating corrugated outer surface potions 114 and non-corrugated outer surface portions 116 may provide the benefit of tailoring the-flexibility of the tube 14. That is, alternating corrugated outer surface potions 114 and non-corrugated outer surface portions 116 may provide flexibility between that of an entirely corrugated tube and an entirely non-corrugated tube. Similar to the examples shown in FIGS. 6 and 8, the alternating corrugated outer surface portions 114 and non-corrugated outer surface portions 116 may also be utilized in a single layer configuration.

The examples of FIGS. 5-9 may provide a:benefit in vehicle systems 12 (FIG. 1) where flexibility is desirable to, for example, assemble or bend the tube 14 around an obstacle in the vehicle 10.

There are several other advantages to the aromatic polyamide tube 14 of the present invention. For one, the tube provides chemical, temperature, and vehicle fluid permeation resistance and can withstand the harsh under-hood environment of a vehicle. The tube is also recyclable and can also be less expensive and lighter in weight than rubber or other plastic tubes.

The invention has been described in an illustrative manner, and it is to be understood that the terminology used is intended to be in the nature of words of description rather than of limitation. Various modifications and variations of the disclosed examples are possible in light of the above teachings. It is, therefore, to be understood that within the scope of the appended claims the invention may be practiced otherwise than as specifically described.

1. A vehicle tubing comprising:
an inner layer of aromatic polyamide forming a tubing conduit, wherein the inner layer of aromatic polyamide is electrically conductive; and
an outer layer of aromatic polyamide adjacent the inner layer of aromatic polyamide.

2.-3. (canceled)

4. The vehicle tubing as recited in claim 1, wherein each of the outer layer of aromatic polyamide and the inner layer of aromatic polyamide includes a layer thickness that together define a total thickness, and the thickness of the outer layer of aromatic polyamide comprises between approximately 50% and 95% of the total thickness.

5. The vehicle tubing as recited in claim 1, including an intermediate thermoplastic layer located between the inner layer of aromatic polyamide and the outer layer of aromatic polyamide.

6. The vehicle tubing as recited in claim 1, wherein the inner layer of aromatic polyamide includes an outer surface and the outer layer of aromatic polyamide includes an inner surface, and the outer surface of the inner layer of aromatic polyamide contacts the inner surface of the outer layer of aromatic polyamide.

7. The vehicle tubing as recited in claim 1, wherein aromatic polyamide of the inner layer of aromatic polyamide and the outer layer of aromatic polyamide include a chemical repeat unit having an amide group and an aromatic ring, and the amide group is attached to the aromatic ring.

8. The vehicle tubing as recited in claim 1, wherein aromatic polyamide of the inner layer of aromatic polyamide and the outer layer of aromatic polyamide include amide groups and aromatic rings, and at least a portion of the amide groups are attached to aromatic rings.

9. The vehicle tubing as recited in claim 8, wherein at least 50% of the amide groups are attached to aromatic rings.

10. The vehicle tubing as recited in claim 8, wherein the aromatic polyamide of the inner layer of aromatic polyamide and the outer layer of aromatic polyamide include at least one of an impact-modifying agent, a heat-stabilizing agent, a heat-stabilizing agent, and a color pigment.

11. The vehicle tubing as recited in claim 1, wherein only the inner layer of aromatic polyamide of the tubing includes an electrically conductive material.

12. The vehicle tubing as recited in claim 33, wherein the electrically conductive material includes at least one of carbon powder, carbon fiber, carbon nanotubes, metal fiber, metal powder, and mixtures thereof.

13. The vehicle tubing as recited in claim 1, wherein the outer layer of aromatic polyamide includes a corrugated outer surface.

14. A vehicle tubing comprising:
a tubing including a layer of aromatic polyamide defining a conduit, the layer of aromatic polyamide including a corrugated outer surface section.

15. The vehicle tubing as recited in claim 34, wherein the inner layer of aromatic polyamide includes a corrugated inner surface section and a corrugated outer surface section that corresponds to the corrugated outer surface section of the outer layer of aromatic polyamide.

16. The vehicle tubing as recited in claim 34, wherein the inner layer of aromatic polyamide includes a non-corrugated inner surface section and a corrugated outer surface section that corresponds to the corrugated outer surface section of the outer layer of aromatic polyamide.

17. The vehicle tubing as recited in claim 34, wherein the tubing includes a length, the inner layer of aromatic polyamide has a first wall thickness and the outer layer of aromatic polyamide has a second wall thickness, and one of the first wall thickness and the second wall thickness is essentially constant over the length of the tubing and the other of the first wall thickness and the second wall thickness changes over the length of the tubing.

18. The vehicle tubing as recited in claim 34, wherein the outer layer of aromatic polyamide includes a non-corrugated outer surface section adjacent to the corrugated outer surface section along a length of the tubing.

19. The vehicle tubing as recited in claim 18, further including alternating non-corrugated outer surface sections and corrugated outer surface sections along the length of the tubing.

20. (canceled)

21. A method of resisting permeation of a fluid through a tubing wall comprising the steps of:
extruding an inner layer of aromatic polyamide to form a tubing conduits;
extruding an outer layer of aromatic polyamide coaxially with the inner layer of aromatic polyamide; and
bonding the outer layer of aromatic polyamide to the inner layer of aromatic polyamide.

22. (canceled)

23. The method as recited in claim 21, including the step of bonding the outer layer of aromatic polyamide to the inner layer of aromatic polyamide with an intermediate thermoplastic layer located there between.

24. The method as recited in claim 21, including the step of forming a corrugated outer surface section on the outer layer of aromatic polyamide.

25. The method as recited in claim 21, including the step of adding at least one of carbon powder, carbon fiber, carbon nanotubes, metal fiber, metal powder, heat-stabilizing agent, impact-modifying agent, and mixtures thereof to the aromatic polyamide used to extrude the inner layer of aromatic polyamide.

26.-30. (canceled)

31. The vehicle tubing as recited in claim 3, wherein the intermediate thermoplastic layer includes polyvinylidene fluoride, ethylene chlorotrifluoroethylene, ethylene tetrafluoroethylene, polyamide, modified polyamide, polyolefin, ethylene vinyl alcohol, polyester, polybutylene napthalate, or combinations thereof.

32. The vehicle tubing as recited in claim 10, wherein the aromatic polyamide of inner layer of aromatic polyamide and the outer layer of aromatic polyamide includes an impact-modifying agent and a heat-stabilizing agent.

33. The vehicle tubing as recited in claim 11, wherein the inner layer of aromatic polyamide has an electric surface resistivity between approximately 10² and 10⁷ ohms/square.

34. The vehicle tubing as recited in claim 14, wherein the layer of aromatic polyamide comprises an inner layer of aromatic polyamide, and the tubing further comprises an outer layer of aromatic polyamide adjacent the inner layer of aromatic polyamide.
